(19) United States
(12) Patent Application Publication
(10) Pub. No.: US 2007/0219967 A1
(43) Pub. Date: Sep. 20, 2007

(54) Patent Invalidation

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,453

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06F 17/30

(52) U.S. Cl. 707/3

(57) ABSTRACT

A database, such as a patent database, including a plurality of electronic documents, such as patents and patent applications, is described. End users are able to access the database and submit prior art that they believe invalidates patent documents in the database. End users may also submit commentary explaining their reasons for submitting the prior art. The system may be configured to reward end users who have a history of submitting prior art that invalidates patent documents and/or to penalize end users who have a history of submitting prior art that does not invalidate or is not relevant to the identified application.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

According to various embodiments, the present disclosure provides a system for ex parte or inter partes patent invalidation. According to an embodiment, patent applications are filed and published. End users can submit prior art documents (or links thereto), in connection with an identified previously filed, published, or pending patent application, or issued patent (hereinafter collectively referred to as “patent documents”). The prior art submissions or hyperlinks thereto are stored or otherwise associated or linked with the identified patent document. Moreover, the date and/or time the documents are submitted may also be indicated and stored.

In some embodiments, users may further submit comments about why the prior art is or may be relevant to the application. Such comments may be provided via any applicable means necessary, including use of blogs and/or notes systems.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application,—includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes.

Patent Application—includes an invention disclosure that has been filed with a registration entity such as the USPTO

Patent Application Drafting Tool—includes a web based software program that assists in the drafting and filing of patent applications with a registration entity such as the USPTO. An exemplary tool for preparing submitting documents via the Internet is disclosed for example, in U.S. patent application Ser. No. 11/627,263 “Automated Web-Based Application Preparation and Submission” filed Jan. 25, 2007, which is incorporated herein by reference.

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As previously stated, according to various embodiments, the present disclosure provides a system for ex parte or inter partes patent invalidation. In certain embodiments, prior art submissions, especially when a hyperlink or other reference is submitted instead of an actual document, are retrieved by the system, either manually or automatically. The source or referenced hyperlinked document, including any and all relevant documents associated with such source or referenced hyperlinked document may be stored using any suitable means, including, for example, in a time and date stamped and/or encrypted file(s). This allows for the capture and future identification of the state and content of such documents at or nearly at the time of submission or at the earliest opportunity thereafter. Accordingly, in the event that the source document is deleted or modified, the saved record(s) can be accessed to determine the state of the document at the time of submission.

In certain embodiments, if the source document referenced by a hyperlink cannot be found, validated, imported, or saved, the system may either reject the assertion of the prior art and/or may warn the end user and/or request that the end user supply such missing or invalid files. Alternatively, the system may proceed and only storing the hyperlink or other references, but may also make a recorded note of the fact that the document could not be found, validated and/or imported. In such cases, the patent examiner, for example, may not consider such prior art and/or may only consider it in searching for other similar art and/or may consider such submissions, for example, based upon the reputation and past performance/reliability of the end user submitting such prior art data.

In certain embodiments, existing or new search tools may be provided to permit end users to search for submitted notes, documents, prior art and/or comments. In some cases, end users may desire to use a search engine that has been modified to provide specific features relating to searching for prior art. Exemplary methods for providing patent and prior art searches are disclosed in U.S. patent application Ser. No. 11/671,380, “Automated Patent Searches” filed Feb. 5, 2007; Ser. No. 11/693,555 “Providing Certified Patent Searches Conducted by Third Party Researchers” filed Mar. 29, 2007; and ______ (Attorney docket No. 3304103) entitled “Enhanced Patent Prior Art Search Engine,” filed Apr. 6, 2007; each of which is hereby incorporated by reference.

In certain other embodiment, additional features and functions may be desirable. Additional methods to create or modify search engines are well known and understood within the prior art and by any person of ordinary skill. For example, methods to design and build a search engine are disclosed and discussed by the authors of the following books, including, for example “Understanding Search Engines: Mathematical Modeling and Text Retrieval (Software, Environments, Tools), Second Edition, by Michael W. Berry and Murray Browne, which is incorporated by reference. Methods to create web pages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of which is hereby incorporated by reference.

In one embodiment, the prior art documents that are submitted, and/or the fact of their submission, cannot be viewed or accessed by anyone except the examiner assigned to the case and/or authorized end users. In other embodiments, the submitted prior art documents, and the fact of their submission, may be made public or made available to only certain parties or individuals. Who is granted access to this information may or may not depend on factors such as whether or not a particular application has published, issued, or otherwise been made public, or whether the application was submitted via an alternative or experimental system, such as a “fast track” or “expedited examination” program.

In certain embodiments, end users or any person or third party may submit prior art, hyperlinks to prior art, and/or commentary regarding such prior art submissions and/or notes regarding the issued or pending patent application. Exemplary methods to provide attachment of notes into documents and/or associate notes with documents, or words, or other data are disclosed in U.S. patent application Ser. No. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference. In addition or in the alternate, a database of such submissions may be created and/or a blog may be established for such purposes.

In some embodiments, a patent examiner or other designated party reviews the application for patentability and/or reviews the prior art documents and/or notes or commentary submitted by end users or any third parties. If the examiner elects to use or cite a prior art document and/or note or commentary to reject a patent application, the first end user or entity and/or others who submitted the prior art and/or notes or commentary may be paid a fee and/or such end user or entity may receive higher priority, respect, or trust when submitting subsequent prior art, notes and/or commentary. By providing a fee or other benefits to end users or entities, an environment conducive and supportive of prior art submissions is thereby established.

In certain embodiments, fees are paid to one or more end users and/or entities that submit prior art, opinions, notes and/or commentary. In come cases, fees are higher or different for those whose prior art, notes and/or commentary are cited, used, or are instrumental in isolation and/or in combination with other prior art, notes and/or commentary, in the examination and/or rejection, and/or invalidation of a pending or issued patent. Such fees may be determined by any applicable means, including, for example, a set fee per occurrence or usage or recitation of any such prior art, note or commentary, and/or variable fees, and/or free market forces, and/or by rule, law or regulation passed or imposed by any duly authorized governing body. For example, a rule or regulation imposed by the USPTO or other governing agency, including, for example, a foreign patent agency, and/or fees may be established via a learning system designed for such purposes.

For example, a genetic algorithm may be implemented that tests various fee structures for different forms, quantities and qualities of prior art, notes and/or commentary submissions, as the system tries various pricing models, the genetic algorithm may use a “fitness test” to determine if there is any relationship between such fees and the resulting quantity and/or quality of any such prior art, notes and/or commentary submissions. If such a relationship exists, a genetic algorithm could exploit this information to optimize the results and pricing models accordingly. In certain embodiments, fees may be shared among two or more persons, end users, or entities, e.g., the USPTO and a web site hosting company.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each of which are incorporated herein by reference.

In certain embodiments, end users that submit prior art may be scored based upon any applicable means, including, for example, on the number of times the prior art and/or notes or commentary they submit is used in a patent application examination and/or is cited and/or is principally or secondarily responsible for issued or pending claims being rejected or invalidated. Such scores may be assigned manually by, for example, patent examiners, and/or via automated means. For example, as, or if, a patent examiner submits an opinion, and such opinion cites any such prior art, notes or commentary as supporting documentation or as a source or foundation of any such opinion, then the system could record any such citation and/or opinion and/or its source or foundation and/or supporting arguments. When storing such information, such a system could also include information about the end user or entity or person that originally or first submitted such materials and/or other information about any one or more end users that submitted such materials. Such scores could be used for a variety of beneficial purposes, including, providing any future examiner(s) with additional information about information supplied by any such end user or entity. This additional information may encourage or discourage an examiner from using the end user's or entities' submissions. For example, if a given end user has proven reliable in providing prior art, notes and/or commentary, patent examiners may be encouraged to review such reliable end user's submissions first and/or exclusively and/or ahead of other less reliable sources. In addition or in the alternate, if a given end user or entity has shown to be generally unreliable, such end user or entities may be barred from further submissions and/or such submissions may be rejected or discounted by the system and/or such poor scores or historical underperformance may be made available to future examiners so that such examiners may opt to not review such materials and/or if such a review is conducted, it may be conducted with benefit of such knowledge of such past poor performance.

In certain embodiments, scores and/or rankings are determined by any suitable means, including by submissions made by any authorized party, which may include any one or more of: patent examiners, patent attorneys, end users, entities, third parties, peer review committees, organizations or groups created for such purposes, etc. Scores may be recorded individually or in the aggregate, for example, there may be scores assigned by patent examiners that are kept separate from all other scores, and/or patent attorneys may also have a separate score, and/or examiner and attorney scores may be combined or averaged, while layperson scores or rankings may be held separately.

In another embodiment, all, some, or groups of submitted or calculated scores are held separately, and/or in detail such that subsequent review for such scores and their accuracy can be determined. For example, if a certain end user's prior art turns out to be instrumental in overturning or rejecting a patent, the system could review the scores previously attached to such end user. If the scores accurately reflected the eventual quality or relevancy of such prior art as submitted by end users, then the person or application providing such score or rank may be determined as a more reliable source or application to provide such ranking.

In other embodiments, scores are only assigned when an outcome is know, i.e., after the end user's submission has either been used or rejected for use by, for example, a patent examiner.

In yet other embodiments, relevancy scores may be determined, in whole or in part, through the use of automated means. In addition to the novel relevancy ranking methods disclosed herein, other methods to determine relevancy between and among documents and/or websites are well known within the prior art, including, for example, the methods discussed in the book entitled “Text Databases and Document Management: Theory and Practice, by Amita Goyal Chin, which is incorporated by reference.

In some embodiments, examiners can request and/or pay for submissions from prior art submitters that are based, in part, on their scores. Fees for such requests may be determined by any applicable means, including, free market forces and/or based upon, in whole or in part on the scores. In certain cases, such fees may be shared between or among two or more persons, entities and/or organizations, e.g., the USPTO and the end user that submitted prior art.

In certain embodiments, end users, e.g., individuals that submit prior art, may have more than one score associated with their submissions and themselves. For example, an individual that submits prior art in more than one field of use may prove more or less reliable depending upon the field of use. Therefore, a database of scores may be established and tracked in order to better understand and predict past and future prior art, notes and/or commentary usefulness and/or relevancy.

In certain embodiments, whenever an end user submits prior art and/or an examiner or other third party submits an opinion, and/or any other changes, submissions, opinions, notes, prior art documents, hyperlinks, or other data changes, is required, is submitted, is approved, or is altered or should be altered, any one or more affected and/or interested parties may be notified of such events via any applicable means such as via e-mail or an alert. For example, if a third party end user submits prior art to a published pending patent application, the inventor(s) and/or assignees and/or inventor's attorneys may be sent an alert or notice of such submission.

According to an embodiment, an AI system can use the prior art submitted by third party submitters to provide search tool enhancements to a search engine used by examiners and the public when examining and drafting patent applications. An exemplary tool for preparing submitting documents via the Internet is disclosed for example, in U.S. patent application Ser. No. 11/627,263 “Automated Web-Based Application Preparation and Submission” filed Jan. 25, 2007, which is incorporated herein by reference.

In certain embodiments, merchants or advertisers may desire to associate one or more advertisements to any patent application or prior art information, including, for example, links or advertisements tied to any one or more of the following, any data, words, figures, images, graphics, icons, etc. Merchants or advertisers may wish to include advertising messages or other marketing content using hyperlinks or other methods. Exemplary methods for including advertising, including charging for such advertising, including the rental, license, purchase or placement of hyperlinks or other applications, modules or other information in such documents are disclosed in U.S. patent application Ser. No. 11/668,586 “Targeted Advertising Based on Invention Disclosures,” filed Jan. 30, 2007; Ser. No. 11/668,596, “Keyword Advertising in Invention Disclosure Documents,” filed Jan. 30, 2007; ______ (Attorney docket No. 3303103) “Merchant Tool for Embedding Advertisement Hyperlinks to Words in a Database of Documents” filed Apr. 6, 2007; and ______ (Attorney docket No. 3303104) “Merchant Tool for Embedding Advertisement Hyperlinks to Words in a Database of Documents,” filed Apr. 6, 2007; each of which is hereby incorporated by reference.

In certain embodiments, before displaying any prior art, patent application, advertisement and/or before presenting a list of prior art, patent applications, including words and/or documents, e.g., from a lexicon of words, and/or any other search results information or data, it may be desirable to ascertain certain additional information about such search request regarding, e.g., prior art, an end user, a patent application, advertisement and/or other request for information. In such cases, the system may determine that it is necessary, desirable or generally useful to present one or more survey questions to aid in determining which prior art, patent applications, words, documents, advertisements, or other information should be presented, e.g., to help determine which prior art or advertisement might yield generally better results, and/or which prior art, word or synonym is generally more relevant given the information known about the end user and/or collected by using and/or displaying and/or gathering results from one or more such survey questions. For example, when an end user enters the word “case” into a search tool designed to retrieve prior art relating to use of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of “case” to include legal cases, and/or the system may also provide an advertisement for one or more attorneys seeking clients, and/or the system may present prior art that includes the word “case” and/or has relevancy to a patent application within a given field of use, etc. Based upon the response to one or more questions, the system may present additional qualifying questions, i.e., additional questions to further narrow the search results and or the sort display results.

Exemplary methods to provide for survey questions and gathering of data are disclosed by applicants in U.S. Patent Application No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

According to some embodiments, end users can create a short or other name for a title of a prior art submission. The search engine looks for other prior art documents or submissions that refer to that name and provides links to them as part of the GUI when displaying that prior art document and/or hyperlink.

According to another embodiment, end users can also link articles to a patent application or prior art submission. For example, an interested third party or end user may wish to submit a magazine article to a patent examiner that is presently reviewing a patent application. Such submission may be in the form of a note, which may include a hyperlink to the source materials.

In another embodiment, the system could compare two or more prior art submissions and remove or delete duplicate entries, and/or reference the two and/or sort them such that they appear generally adjacent to one another.

According to an embodiment, prior art contributed to different sections of a patent can have different relevance weights for subsequent searches by end users and spiders or web crawlers. For example, prior art contained within the prior art and claims sections may carry a generally higher weight or ranking than prior art associated with the abstract section of the patent application.

According to another embodiment, the number of times a document is downloaded, cross referenced, hyperlinked, or contributed to may have an effect on its search relevance to spiders, web crawlers, end users, and/or to its ranking. For example, if within a single prior art submission, there are five hundred entries, but numerous end users repeatedly review entry numbers: 7, 212, and 327, such three entries may be move up partially to the top of the prior art submission or to the top of the submission and/or such entries may be flagged as potentially being generally more relevant than other less frequently accessed/reviewed entries. The order of such entries may be determined, in whole or in part, by the number of times accessed, the nature or qualifications or other attributes of those accessing such entries, e.g., entries accessed more frequently by a patent examiner may carry more weight than by third parties.

In certain embodiments, certain end users may have special privileges or restrictions regarding access to or use of the notes system and/or one or more of its features and/or benefits. For example, an Inventor/Assignee/Attorney may have a special log in that allows them to post prior art submissions, which other end users or third parties cannot. The system validates that the end user has a special relationship to the prior art submission, document, action or method stop and/or is otherwise authorized to perform a given task or tasks and provides senior editing and prior art, notes and document adding or other privileges/restrictions to that end user log on. Such privileges and/or restrictions include, but are not limited to, the ability to:
1. Log into the hyperlink, prior art, document or note creation or editing program(s)
2. Access to or the ability to create and/or submit prior art, and/or a hyperlink, source document, opinion or note
3. Make changes or delete a prior art submission, hyperlink, source document, opinion or note.
4. Rank or score a prior art document, hyperlink, opinion, mapping information or note
5. Provide biographical information
6. Provide supporting or detracting information, documents, hyperlinks or notes to any prior art document, hyperlink, document or note or any combination of these.
7. Establish and/or modify and/or submit and/or review rules, regulations or programs that control submission, review and/or approval of any prior art, documents, hyperlinks, rules or other information or programs
8. Create, modify or remove any function or practice any of the invention as disclosed herein and/or by any of the applications incorporated herein by reference.
9. Establish, create or otherwise determine a price or fee or tax to be levied, accrued, charged or otherwise collected relating to any submission of any prior art, document, hyperlink or note or other information, and/or any of the forgoing actions, procedures and/or for granting or accepting any such authorizations or permissions and/or to make use of any document, hyperlink or note.
10. Make, suggest or submit corrections to any of the above
11. Access, or the right to grant the ability to permit others to access, or to grant end users to any of the above-mentioned systems and/or to authorize others to perform or obtain or grant any permissions or authorizations or any combination of the above.
12. Or any combination of the above.

In another embodiment, the system can permit an end user to attach prior art and/or a note to a group of documents, e.g. patent applications. For example, in addition to providing prior art and/or a note for a single patent application, an end user can select a group of patents and/or sections of that group of patents and provide prior art and/or notes for the group or sections from that group. In this fashion, a single prior art submission and/or note or part of a note can be simultaneously associated with or otherwise linked to more than one document.

In certain embodiments, all or some prior art, documents, notes, hyperlinks, entries and revisions shall carry a time and date stamp. A time and date stamp and/or change tracking may be encrypted to prevent unauthorized or fraudulent modifications. In such cases, change tracking would permit end users and/or only certain authorized end users to determine the various states of any such prior art, documents, definitions, notes, images, video, audio, documents, or text, etc., at the time of each such change, update or modification. In this fashion, the priority of ideas, e.g., within a patent application may be determined by an authorized end user, e.g., a patent examiner or a court of competent jurisdiction. In addition or in the alternate, such change tracking may retain a copy of the data before and after any such change or update.

According to another embodiment, spiders or WebCrawlers or other applications that scan prior art, documents, opinions, notes or web pages, can comb through, i.e., examine, digital articles and documents and automatically create notes for a document based on how the document is discussed in other documents and/or notes.

In certain embodiments, end users may desire to search prior art, notes, opinions, words, documents or databases, for example, a patent database, to find relevant prior art, opinions, notes, words, documents, e.g., patents and/or prior art that may require lexicon updates and/or definitions, synonyms and/or antonyms. Exemplary methods for providing patent and prior art searches are disclosed in U.S. patent application Ser. No. 11/671,380, “Automated Patent Searches” filed Feb. 5, 2007; Ser. No. 11/693,555 “Providing Certified Patent Searches Conducted by Third Party Researchers” filed Mar. 29, 2007; and ______ (Attorney docket No. 3304103) entitled “Enhanced Patent Prior Art Search Engine,” filed Apr. 6, 2007; each of which is hereby incorporated by reference.

In other embodiments, end users may desire to prioritize the processing of their prior art or other submissions, documents, notes, opinions, reviews, commentary or other tasks or items submitted to a queue. In such cases, methods to provide for prioritization may be desirable. Exemplary methods for priority queuing documents are disclosed for example in U.S. patent application Ser. No. 11/462,621, “Fee-Based Priority Queuing for Insurance Claim Processing,” filed Aug. 4, 2006; Ser. No. 11/611,024 “System and Method for Prioritizing Items in a Queue” filed Dec. 14, 2006; and PCT Application No. PCT/US06/340347, “Insurance Form Priority Queuing;” each of which are incorporated herein by reference.

In certain embodiments, surveys, notes, advertisements and hyperlinks may be interchangeable terms, e.g., a survey can be a note, and a note can be a survey or a survey can include an advertisement or vice versa.

In certain embodiments, a visual representation of relationships and/or relevancy between two or more of: patent applications, prior art, notes, opinions, documents and/or other data, may be created to aid end users in accessing, searching, reviewing or analyzing any such information, documents and/or data. For example, a prior art map may be produced showing, e.g., at the top, the name or ID of a pending patent application, then, a map to all submitted prior art, and/or other documents. Such map may include relevancy information, e.g., more relevant items may be color coded, or a line connecting such more relevant items may have a thicker line or may be sorted or appear closer to the source patent application document, etc. A visual map showing such representations may be made by any applicable means, including methods described herein and/or methods disclosed in U.S. Patent Application No. ______ (Attorney docket No. 3303104) entitled “Self-Teaching Thesaurus,” filed Apr. 6, 2007.

In some embodiments, when end users submit prior art, such prior art may undergo a review and/or approval process. Such processes may be manual and/or automated. For example, prior to attaching or associating any prior art to any given patent application or other document(s), such prior art may first require a review by a patent examiner or other designated or authorized third party, and/or such prior art may be accessed, e.g., via a hyperlink, to determine if it exists and if it can be captured, encrypted, imaged and/or stored with an optional time/date stamp. Such approval process may be accomplished via any applicable means, including those disclosed/described herein.

In certain embodiments, the disclosed invention may be practiced in the real or virtual world. For example, a video game may include a virtual patent office, wherein such patent office may review one or more patent applications, and wherein one or more end users, players, or player characters and/or other third parties, may submit one or more sources, documents, hyperlinks, etc., that may serve as prior art. Exemplary methods and systems for providing protection of intellectual property in a virtual environment are disclosed, for example, in U.S. patent application Ser. No. 11/428,263, “Video Game Environment” filed Jun. 30, 2006; Ser. No. 11/620,563 “Copyright of Digital Works in a Virtual Environment,” filed Jan. 5, 2007; Ser. No. 11/689,977, “Digital Rights Management in a Virtual Environment,” filed Mar. 22, 2007; Ser. No. 11/671,373 “Video Game with Control of Quantities of Raw Materials” filed Feb. 5, 2007; Ser. No. 11/680,960 “System for the Creation and Registration of Ideas and Concepts in a Virtual Environment,” filed Mar. 1, 2007; each of which is incorporated herein by reference. Accordingly, the disclosed invention may be applied to such virtual environment, world or video game(s) or any combination of the forgoing. For example, commentary and opinions and/or scoring, such as those disclosed herein may be created, used and/or delivered in the virtual world. Furthermore, virtual patent examiners (which may or may not be real world patent examiners too), may be used to provide patent opinions regarding a player's or player character's patent application for a virtual object.

The disclosed invention could be also be used for the creation of agreements between or among real or virtual end users, players, player characters or other third parties. In such cases, methods to ensure that agreements are enforceable and that advertising fees are collected in such virtual environments are desirable. Exemplary methods for providing such contract enforcement and collection of fees are disclosed, for example, in U.S. patent application Ser. No. 11/279,991 “Securing Virtual Contracts with Credit,” filed Apr. 17, 2006; Ser. No. 11/624,662 “Securing Contracts in a Virtual World,” filed Jan. 18, 2007; Ser. No. 11/559,158 “Financing Options in a Virtual World” filed Nov. 13, 2006; Ser. No. 11/620,542 “Satisfaction of Financial Obligations in a Virtual Environment Via Virtual and Real World Currency,” filed Jan. 5, 2007; Ser. No. 11/421,025 “Financial Institutions and Instruments in a Virtual Environment,” filed May 30, 2006, and Ser. No. 11/380,489 “Multiple Purchase Options for Virtual Purchases,” filed Apr. 27, 2006; each of which are hereby incorporated herein by reference.

In other embodiments, comments, opinions and/or notes may also be used to provide feedback regarding game play, enjoyment, features, desired features, discovered errors, and/or any other form of communication and/or ranking information.

It will be appreciated that all embodiments herein which refer to a patent are equally applicable to a patent application, and vice versa, unless explicitly stated otherwise with respect to a particular embodiment. The references to a patent (or to a patent application) are for reasons of brevity only.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:
1. Prior Art Submission Program
2. Patent Application Filing Program
3. Billing and Payment Program
4. Prior Art and Searcher Scoring Program
5. AI Search Improvement Program

Exemplary database architecture includes:

Patent Application Database
a. Patent Application ID
b. Application Serial Number
c. Pending Application Number
d. Issued Patent Number
e. Patent Applicant Name(s) 1-N
f. Applicant, i.e., User ID
g. Inventor City
h. Inventor State
i. Inventor Country
j. Assignee Name
k. Assignee City
1. Assignee State
m. Assignee Country
n. Title
o. Abstract
p. Application Date
q. Short Description
r. Long Description
s. Claims
t. Attorney or Agent Name
u. Attorney or Agent ID
v. Specifications/Descriptions
w. Filed of Use
x. Current US Classification
y. Current International Classification
z. Primary Examiner
aa. Assistant Examiner
bb. Parent Case Information
cc. Related Application Data (e.g. US)
dd. Referenced By
ee. Reissue Data
ff. Foreign References
gg. Foreign Priority
hh. Other References
ii. PCT Information
jj. Government Interest
kk. Application Type
ll. Hyperlinks (e.g., document locations) 1-N
mm. Class 1-N
nn. Subclass 1-N
oo. Type 1-N
pp. Subtype 1-N
qq. Additional Date/Time Stamps/Change Tracking Data
   a. Submitted/Found/Indexed On
   b. Submitted/Found/Indexed By ID or Hyperlink
   c. Published y/n
   d. Published Date
   e. Revised On 1-N
   f. Revised By 1-N
   g. Before Image 1-N
   h. After Image 1-N
   i. Rejected/Issued?
   j. Rejected/Issued Date
   k. Notes 1-N

End User Database
1. User ID
2. Name
3. Account Type
4. Description
5. Terms and Conditions ID
6. Credit Card Information
   a. Preferred Card Number
   b. Preferred Card Holder
   c. Preferred Card Type
   d. Name
   e. Expiration Date
   f. Security Code
7. Additional Cards 1-N
   a. Card Number
   b. Card Holder (e.g., Bank Name)
   c. Card Type (e.g., Visa)
   d. Name
   e. Expiration Date
   f. Security Code
8. Areas of practice/Fields of Use (if attorney) 1-N
9. Contact Information
10. Qualifications 1-N
11. Skills 1-N
12. Current Cases ID 1-N
13. Prior Cases ID 1-N
14. Notes 1-N
15. Relevancy/Performance Data ID 1-N

Relevancy/Performance Data
1. ID
2. Description
3. Type
4. Summary Relevancy Score
5. Detailed Relevancy Transaction Data
   a. Transaction ID
   b. Transaction Type
   c. Document, Patent Application, Note or other ID
   d. Score
   e. Score Provided By System or ID 1-N
   f. On Date 1-N
6. Contest Transaction ID

Prior Art Database
1. Prior Art ID
2. Patent Application ID 1-N
3. Submitted By, i.e., User ID 1-N
4. Prior Art Hyperlink IDs (e.g., document locations) 1-N
5. Prior Art Attached Documents, Figures, Images, etc. 1-N
6. Prior Art Source Descriptions 1-N
7. Relevancy Scores 1-N
8. Relevant Prior Art Submissions-Prior Art IDs 1-N
9. Group 1-N
10. Class 1-N
11. Subclass 1-N
12. Type 1-N
13. Subtype 1-N
14. Additional Date/Time Stamps/Change Tracking Data
   a. Submitted/Found/Indexed On
   b. Submitted/Found/Indexed By ID or Hyperlink
   c. Published y/n
   d. Published Date
   e. Revised On 1-N
   f. Revised By 1-N
   g. Before Image 1-N
   h. After Image 1-N
   i. Rejected/Issued?
   j. Rejected/Issued Date
   k. Notes 1-N

Group Database
1. Group ID
2. Description
3. Includes Sub-Groups/Sub-Class IDs 1-n
4. Notes 1-N

Class
1. Class ID
2. Description
3. Includes Sub-Class IDs 1-N
4. Notes 1-N

Sub Class
1. Subclass ID
2. Description
3. Notes 1-N

Note Class
1. Note Class ID
2. Description
3. Includes Sub-Class IDs 1-N
4. Notes 1-N

Note Subclass
1. Note Subclass ID
2. Description
3. Notes 1-N

Hyperlink Database
1. Hyperlink ID
2. Description
3. Security Data
   a. User ID
   b. Password
   c. Encryption Key(s) 1-N
4. Hyperlink (e.g., URL)
5. Submitted by User ID
6. Date Submitted On
7. Date Revised On 1-N
8. Description
9. Notes 1-N

Notes (opinions and commentary) Database
1. Note ID
   a. Hyperlinks 1-N
   b. Note Description Short
   c. Note Description Long
   d. Note Group ID
   e. Note Class ID
   f. Note Subclass ID
   g. Note and/or Note Attachments 1-N
      1. Submitted By ID
      2. Original Submission Date/Time
   h. Notes 1-N
2. Modifications 1-N
   a. Submitted By ID
   b. Modification Submission Date
   c. Short Description
   d. Long Description
      1. Submitted By ID
      2. Original Submission Date/Time
      3. Hyperlinks 1-N
      4. Change Images 1-N
         a. Before Change Image
         b. After Change Image
   e. Notes 1-N

Billing Database
1. Billing Transaction ID
2. Date/Time Stamp
3. Type
4. Billing Method ID
5. Bill From ID 1-N
6. Bill To ID 1-N
7. Fee ID 1-N
8. Amount 1-N
9. Description 1-N
10. Transaction Detail IDs 1-N
11. Terms and Conditions 1-N
12. Billing Rules 1-N

Fees Database
1. Fee ID
2. Fee Type
3. Description
4. Fee Rules 1-N

Examiner Database
1. Examiner ID
2. Name
3. Areas of practice/Fields of Use 1-N
4. Contact Information
5. Qualifications 1-N
6. Skills 1-N
7. Current Cases ID 1-N
8. Prior Cases ID 1-N
9. Docket Numbers—1-N
10. Relevancy/Performance Data ID 1-N
11. Notes 1-N

Qualifications Database
1. Qualification ID
2. Description
3. Qualification Type
4. Years Experience
5. Fields of Use Applicable 1-N
6. Notes ID 1-N

Skills Database
1. Skill ID
2. Description
3. Type
4. Years Experience
5. Fields of Use Applicable 1-N
6. Notes ID 1-N

Billing Terms and Conditions Database
1. Billing Method ID
2. Billing Type
3. Description
4. Billing Frequency
5. Due by # days
6. Late by # days
7. Interest Rate Fixed
8. Interest Rate Variable
9. Interest Accrues after days
10. Notes 1-N

Accounts Receivable Database
1. User ID
   Total Amount Owed
2. Transaction Detail Records 1-N
   a. Date of Transaction
   b. Type
   c. Document ID
   d. Word ID
   e. Hyperlinks 1-N
   f. Amount
3. Notes 1-N

Transaction Database
1. Transaction ID
2. Description
3. Date/Time
4. Type
5. User ID
6. Examiner ID
7. Transaction Details
   a. Document, Patent, Note, Opinions, Prior Art ID 1-N
   b. Relevancy Data
   c. Submitted By
   d. Submitted On Date/Time
   e. Hyperlinks 1-N
   f. Attachments 1-N
   g. Original Image Capture
   h. Capture Date/Time
   i. Modified Image(s) 1-N
      1. Modification(s) Submitted By 1-N
      2. Date Submitted 1-N
      3. Before Image 1-N
      4. Before Image Date/Time 1-N
      5. After Image 1-N
      6. After Image Date/Time 1-N
   j. Billing T&C's 1-N
   k. Billing Method ID
   l. Billing Rules 1-N
   m. Transaction Amount
   n. Notes 1-N

Examiner Rules Database
1. Rule ID
2. Rule Description
3. Rules 1-N
4. Notes 1-N
5. Security Rules ID 1-N

Billing Rules Database
1. Rule ID
2. Rule Description
3. Rules 1-N
4. Notes 1-N
5. Security Rules ID 1-N

Fees—Rules Database
1. Rule ID
2. Rule Description
3. Rules 1-N
4. Notes 1-N
5. Security Rules ID 1-N

Thesaurus Notes Database
1. Thesaurus Note ID
2. Notes 1-N

Alert Event Rules Database
1. Alert Event Rule ID
2. Alert Event Description
3. Alert Event Rules 1-N
   a. Event Condition
   b. Alert Recipient ID 1-N
      1. Alert Method 1-N
   c. Alert Database ID 1-N
4. Notes 1-N

Search Database
1. Document ID
2. Document Location/Hyperlink
3. Notes 1-N

Map Database
1. Map ID #
2. Description
3. Notes 1-N
4. Source Document (e.g., prior art) ID #
   a. Source Words ID # 1-N
   b. Map references (sources) ID 1-N
   c. Map references (nodes) ID 1-N
   d. Map references (other) ID 1-N
   e. Related Document or Word ID # 1-N
      1. Type ID (e.g., word or document, etc.)
      2. Related Document or Word ID # 1-N
      3. Related Document or Word ID Relevancy Score, %, or Rank
      4. Map references (sources) ID 1-N
      5. Map references (nodes) ID 1-N
      6. Map references (other) ID 1-N
      7. Notes 1-N

Alert Database
1. Alert Database ID
2. Alert Contents, one or more of:
   a. Text
   b. Variable Data
   c. Executable
3. Notes 1-N

Alert Methods Database
1. Alert Method ID
2. Method Type
3. Delivery Method (cell phone, pager, e-mail, PDA, database, executable, etc.)
4. Notes 1-N

Alert Recipient Database
1. Alert Recipient ID (e.g., end user ID)
2. Description
3. Alert Method Preferences ID 1-N
4. Notes 1-N

It will be appreciated that the various software and hardware components described above will be configured to perform a variety of functions and methods. Listed below are some exemplary methods that might be performed by the systems as described herein:

Attach Prior Art to Published Application
1. Receive a request to attach a prior art data to a published document
2. Output prior art attachment form
3. Receive prior art data
4. Store prior art data with published document

Review Attached Prior Art
1. Retrieve a document record
2. Retrieve prior art data attached to record
3. Flag prior art data as “reviewed”

Pay End Users if Prior Art Was Used to Reject Patent
1. Generate/Receive an office action
2. Determine if office action sites prior art data attached to published document
3. Retrieve user payment information associated with prior art data
4. Pay user

Score Prior Art
1. Retrieve prior art data attached to a published document
2. Score prior art data base on relevancy rules
3. Store prior art data with scores

Score End User
1. Retrieve prior art data submitted by an end user
2. Determine usefulness of data base on rules
3. Score end user based on usefulness of data
4. Store end user score

Improve Search Engine Based on Prior Art Submissions
1. Retrieve prior art data submissions
2. Apply genetic algorithm to prior art data submissions
3. Enhance genetic algorithm based on prior art data submissions

Event Driven Model
1. Load Databases
2. Initially populate or create empty databases
3. Update Databases

Primary Application/Watchdog
1. Load Database(s)
2. Determine if one or more sub-applications should be executed
3. Execute appropriate sub-applications (see below)
4. Update Database(s)
5. Repeat Process as Necessary/Desired/Indicated

User Interface Application
1. Load database(s)
2. Display graphical user interface for each application/feature as requested/desired
3. Receive input from end users
4. Receive data from sources, e.g., via hyperlinks
5. Execute functions as requested/required and/or load additional applications/GUIs
6. Update databases

Security Application
1. Load Database(s)
2. Determine if requested action and/or end user is permitted
3. If not, notify application and/or end user
4. If yes, permit requested step and/or loading of application or other authorized action(s)
5. Update Database(s)

Opt In/Sign Up Application
1. Load Databases
2. Receiving Indication of new user sign up
3. Record any and all or available information regarding one or more patent applicant's, end users, examiners, attorneys and/or third parties
4. Update databases

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Create/Maintain Prior Art (Document) Database
1. Load Databases
2. Determine available or participating documents
3. Periodically search all available documents
4. Create/update index for all found (or participating) documents
5. Receive indication of or end user request to add/change/delete prior art
6. If required, queue and review request(s)
7. If required, approved or reject request(s)
8. Create/update prior art document databases
9. Update databases

Prior Art, Document, Opinion, Notes Search/Indexing Program
1. Load Database(s)
2. Determine Search/Index Procedure is necessary or desired
3. Search World Wide Web or all accessible or participating databases
4. Index Prior Art, Documents, Opinions, Notes and Hyperlinks
5. Store Results
6. Update Database(s)

Prior Art Document Submission/Filing Application
1. Load Database(s)
2. Receive indication/request to submit prior art document(s) or hyperlink(s)
3. Capture image of all relevant materials, including then current definitions, along with Time/Date stamp information
4. If desired, encrypt any or all output materials, e.g., prior art, notes, patent applications, definitions, words, synonyms, antonyms, figures and/or related documents and/or supporting materials to prevent or otherwise control subsequent access and/or modifications
5. Update Database(s)

End User Contest Application
1. Load Database(s)
2. Receive Indication that one or more end users and/or third parties, e.g., patent examiner, contests one or more prior art submissions, notes, opinions and/or other documents, maps and/or supporting materials
3. Determine relevancy/validity of the contest by any one or all of the following if desired/applicable
   a. Solicit other end user/third party votes/scores/ranking
   b. Use GA
   c. Submission to authorized end user or third party
   d. Preponderance of feedback
4. If contest is determined valid, accept requested changes
5. Otherwise reject requested changes
6. Update Database(s)

Word Search/Indexing Program
1. Load Database(s)
2. Determine Search/Index Procedure is necessary or desired
3. Search World Wide Web or all accessible or participating databases/words
4. Index Words and Hyperlinks
5. Store Results
6. Update Database(s)

Opinion/Note Attachment Program
1. Load Database(s)
2. Provide Attachment Creation GUI
3. Receive New Opinion/Note from End User, e.g. Examiner
4. Create Opinion/Note
5. Create Opinion/Note Hyperlink
   a. Associate Opinion/Note with Document, e.g., patent application and/or prior art, Word and/or Hyperlink (as applicable), by, e.g., inserting or otherwise associating Note Hyperlink with Prior Art, and/or Document, Word and/or Hyperlink
   b. Update Database(s)

Opinion/Note Modification Program
1. Load Database(s)
2. Provide Modification GUI
3. Receive Opinion/Note Change/Delete Request from End User, e.g., examiner
4. Create Opinion/Note Modification
5. If required, Create Revised Opinion/Note Hyperlink
6. Associate Revised Opinion/Note with Prior Art or Document, Word and/or Hyperlink, by inserting or otherwise associating Note Hyperlink with Prior Art, Document, Word and/or Hyperlink
7. Else, if required, delete Opinion/Note Hyperlink
8. Update Database(s)

Opinion/Note Access/Use Program
1. Load Database(s)
2. Provide Access/Use GUI
3. Receive opinion/note access/use/activation request from end user (or application), e.g., patent applicant or attorney
4. Apply Relevancy Filter (if applicable/requested/desired)
5. Determine action steps, e.g., execute program or hyperlink:
   a. If applicable, perform one or more of the following:
      1. Display appropriate opinion/note contents
      2. Display like notes, opinions, prior art, documents or hyperlinks to like documents, and/or words, hyperlinks, etc.
      3. Execute program or hyperlink
      4. Display opinion, document, prior art, note and/or advertisement
      5. If desired/applicable, open new window to display opinion/note contents, prior art or advertisement and/or GUI's
      6. Execute opinion/note attachment program
6. Update Database(s)

Prior Art/Opinion/Note Attachment Program
1. Receive indication of new or modified or deleted prior art/opinion/note
2. Load Database(s)
3. If desired, capture before/after change images
4. Create or update or remove hyperlink(s) as required
5. Update database(s)

Find Like Prior Art, Opinions, Notes, Documents, Words, Hyperlinks Program
1. Load database(s)
2. Receive indication any new or modified prior art, opinion, note, document, or hyperlink has been indexed
3. Search for relevant prior art, opinions, notes, documents, or hyperlinks
4. Index results
5. Update database(s)

Prior Art/Opinion/Note Relevance Program
1. Load Database(s)
2. Receive Relevancy Input from End Users
3. Or use automated application to determine relevancy, e.g., via GA
4. Associate Relevancy with Prior Art/Opinions/Notes and/or Documents
5. Update Database(s)

Prior Art/Opinion/Note Search Review Program
1. Load Databases
2. Present Search GUI
3. Receive Prior Art, Opinions, Notes or Documents or other Search String Request
4. If desired, needed or requested, retrieve synonyms and display in separate search string box
5. Receive indication that end user prefers or clicks on synonym or other hyperlink
6. Determine if additional information and/or a survey is needed desired
7. If needed or desired, execute survey program
8. Determine if advertisement should be displayed
9. Display advertisement if desired, needed, requested
10. Based upon available information, e.g., search string, synonyms and/or survey results, Search any or all available and/or participating databases and/or data warehouses
11. Retrieve results including opinions, notes, prior art, other documents, synonyms, antonyms, advertisements, notes, hyperlinks, cases, and other search results data based upon any one or more of the forgoing and/or other search criteria
12. Determine weights, sort, filter and other system and/or end user search criteria of end user requesting search
13. Determine relevancy of results text/data/documents, etc. based upon any one or more criteria including:
   a. Opinion/Note Type, Group, Class or Subclass
   b. Prior Art, Patent Application, and/or Document Type, Group, Class or Subclass
   c. User Type
   d. Security Privileges—Permissions or denials
   e. User Preferences, weighting criteria
   f. Computer Type
   g. Search Engine Type or Provider Preferences
   h. Relevancy Conditions/Information
   i. Document results section weighting
   j. Survey Questions and/or responses
   k. Past or present end user feedback
14. Determine if results data should be displayed in one or more separate page(s), popup or other window(s)
15. Display results, in whole or in part, based upon relevancy, weighting factors, document section information, and/or in sorted/filtered order and/or store results in certified or encrypted database for subsequent user or examiner or third party access, and/or other available relevancy, sorting, display options criteria
16. Display one or more of the following, in whole or in part, if indicated, requested, needed or otherwise desired including, but not limited to:
   a. Prior Art
   b. Patent Application Information
   c. Opinions
   d. Notes
   e. Comments
   f. Relevancy information
   g. End user weighting, criteria, sort, filter and/or display and/or other preferences or system settings
   h. Mapping information
   i. Synonyms and/or antonyms
   j. Definitions
   k. Figures
   l. Text
   m. One or more Documents
   n. Hyperlinks
   o. Advertisements
   p. Or any other search or database results data
   q. Any or all other data as desired/requested/necessary
17. Update Databases

Feedback and Performance Improvement Application
1. Load Databases
2. Receive indication of end user or system activity
3. Determine if end user feedback is indicated, required, necessary offered or is otherwise submitted or provided
4. Determine feedback category, including any one or more of the following categories/items, including the relevancy, accuracy, usefulness, completeness, effectiveness or appeal of any one or more of the following system settings, and/or data including, but not limited to:
   a. Prior Art
   b. Results data
   c. Opinions
   d. Notes
   e. Comments
   f. Relevancy information
   g. End user weighting, criteria, sort, filter and/or display or other preferences or system settings
   h. Mapping information
   i. Synonyms and/or antonyms
   j. Definitions
   k. Figures
   l. Text
   m. One or more Documents
   n. Hyperlinks
   o. Advertisements
   p. Ease of application or feature use
   q. Any or all other data as desired/requested/necessary
5. Request feedback and/or changes to and/or opinions regarding or relating to one or more affected end users regarding one or more feedback categories as defined/determined above and receive feedback information including at least one or more of the following, including, but not limited to:
   a. Relevancy rankings
   b. Scores
   c. Weighting factors or weights
   d. Sorting preferences
   e. Filtering preferences
   f. Display preferences
   g. Subjective criteria
   h. Notes
6. Use on screen feedback option or survey to solicit feedback
7. Receive end user feedback
8. Determine and update relevancy, weighting criteria and/or other scores
9. If feedback warrants, or so indicates, request additional feedback on the feedback
10. Modify applicable/affected criteria including, but not limited to any relevant settings such as those relating to any one or more or part or all of a/an/the:
   a. Genetic or other learning algorithms
   b. Relevancy or scoring algorithms
   c. System, end user and/or other settings, weights, preferences, sort, selection, display criteria.
   d. End user or system weighting, criteria, sort, filter and/or display and/or other preferences or system settings
   e. Prior Art
   f. Mapping information
   g. Opinions
   h. Synonyms and/or antonyms
   i. Definitions
   j. Figures
   k. Text
   l. Documents
   m. Hyperlinks
   n. Advertisements
   o. Notes
   p. Any or all other data as desired/requested/necessary
11. Update databases

Usage Tracking and Optimization Program
1. Load Databases
2. Receive indication of end user or system activity
3. Store/analyze activity
4. When/if requested generate usage tracking/activity reports
5. Display reports and/or export data as requested/desired/needed
6. Determine if activity affects or is related to and/or is otherwise correlated to/with and/or could improve any results data including or system performance, including for example:
   a. Relevancy and/or scoring calculation methods or algorithms
   b. Accuracy and/or quality of prior art submissions/opinions/notes/comments, and/or
   c. Advertising results
   d. Click through results
   e. Conversion rates
   f. End user feedback
   g. End user skills
   h. Search methods or algorithms
   i. Hyperlink use or relevancy
   j. Sort and/or filter methods, calculations and/or options
7. Provide performance data to genetic or other algorithm(s)
8. Modify methods and/or algorithms and/or end user or other options based upon performance data
9. Update Databases

Billing Program
1. Load Database(s)
2. Receive indication that billing activity has occurred
3. Determine affected parties, e.g., payer and payee
4. Determine billing rules, terms and conditions
5. Determine billing amounts due
6. Create Invoice and A/P or A/R notices/entries
7. Send Invoices and notices
8. Update Databases
9. Await Payment
10. Receive payment indication
11. Apply payments
12. Notify A/P or A/R systems/and/or affected parties
13. Determine if payments are timely/sufficient
14. If not, execute collections program
15. Update Database(s)

Collections Program
1. Receive indication payments are late and/or insufficient
2. Load Database(s)
3. If applicable, execute one or more of the following steps:
   a. Send late notice
   b. Send insufficient payment or funds notice
   c. Limit or prevent further use until payment terms are partially or fully satisfied, each according to billing terms and conditions and/or rules
   d. Collect funds due from primary and/or secondary credit cards on file.
   e. Notify affected parties
4. Update Database(s)

Mapping Program
1. Load Databases
2. Receive indication that one or more patent applications, prior art, opinions, notes, comments, words, synonyms, antonyms and/or other documents or hyperlinks or notes have been added or changed or removed from one or more databases
3. Receive or determine relevancy information
4. Determine mapping relationships among any one or more of the forgoing
5. Monitor patent application, prior art, notes, opinions, commentary, word, synonym, antonym, and/or other documents and/or mapping usage
6. Receive feedback from end users and/or determine change in mapping relationships and/or relevancy
7. If desired or required, submit any such changes for review/approval
8. If approved, update mapping relationship data accordingly
9. Update Databases

Survey Program
1. Load Databases
2. Receive indicator that relevancy information should be updated and/or search results may be improved with survey results data
3. And/or periodically submit one or more survey questions to one or more end users
4. Determine questions based upon survey database rules and/or based upon prior effectiveness of one or more survey questions
5. Determine respondent or target end users
6. Submit questions to respondent(s)
7. Receive results
8. Determine new relevancy scores
9. Update relevancy information and/or modify hyperlinks, prior art submissions, opinions, performance data, mapping information or advertisements based upon new or revised relevancy scores and/or other end user feedback
10. And/or use GA to determine relevancy scores and/or hyperlink and/or advertisements
11. Update databases

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing an electronic database of patent documents to a plurality of end users;
providing a user interface configured to:
enable the end users to view the patent documents in the database;
enable the end users to submit prior art in reference to one or more of the patent documents in the database;
identifying the prior art submitted by a given end user; and
determining the frequency with which the prior art submitted by the given end user is used to invalidate a patent document.

2. The method of claim 1 further comprising bestowing a benefit upon the end user if the frequency is determined to be above a given threshold.

3. The method of claim 2 wherein the benefit is increased significance placed on future prior art submissions submitted by the end user.

4. The method of claim 2 wherein there is a fee associated with submitting prior art documents and the benefit is a reduced fee.

5. The method of claim 2 wherein the benefit is monetary compensation.

6. The method of claim 2 wherein the benefit is expedited examination of a patent application submitted by the end user.

7. The method of claim 1 further comprising penalizing the end user if the frequency is determined to be below a given threshold.

8. The method of claim 7 wherein the penalty is decreased significance placed on future prior art submissions submitted by the end user.

9. The method of claim 7 wherein the penalty is a ban from submitting prior art in connection with other patent documents.

10. The method of claim 7 wherein there is a fee associated with submitting prior art documents and the benefit is an increased fee.

11. A method comprising:
providing a database of patent documents to a plurality of end users;
receiving a prior art document from an end user, wherein the prior art document is submitted in conjunction with a patent document in the database,
reviewing the prior art document;
determining that the patent document is invalid based on the prior art document;
providing a tangible benefit to the end user.

12. The method of claim 11 wherein the tangible benefit is monetary compensation.

13. The method of claim 11 wherein the tangible benefit is expedited examination of a patent application submitted by the end user.

14. The method of claim 11 further comprising receiving commentary from the end user identifying why the prior art is believed to invalidate the patent document.

15. The method of claim 11 further comprising tracking the frequency with which prior art documents submitted by the end user are used to invalidate a prior art document.

16. The method of claim 15 further comprising bestowing a benefit upon the end user if the frequency is determined to be above a given threshold.

17. The method of claim 2 wherein the benefit is increased significance placed on future prior art submissions submitted by the end user.

18. The method of claim 16 wherein there is a fee associated with submitting prior art documents and the benefit is a reduced fee.

19. The method of claim 15 further comprising penalizing the end user if the frequency is determined to be below a given threshold.

20. The method of claim 19 wherein the penalty is decreased significance placed on future prior art submissions submitted by the end user.
